(19) United States
(12) Patent Application Publication
(10) Pub. No.: US 2014/0081713 A1
(43) Pub. Date: Mar. 20, 2014

(54) INFLUENCING SERVICE PROVIDER PERFORMANCE USING OBJECTIVE AND SUBJECTIVE METRICS

(71) Applicant: INTERNATIONAL BUSINESS MACHINES CORPORATION, Armonk, NY (US)

(72) Inventors: Wesley M. Gifford, New Canaan, CT (US); Anshul Sheopuri, White Plains, NY (US); Lav R. Varshney, Yorktown Heights, NY (US)

(73) Assignee: INTERNATIONAL BUSINESS MACHINES CORPORATION, Armonk, NY (US)

(21) Appl. No.: 13/680,002

(22) Filed: Nov. 16, 2012

Related U.S. Application Data
(60) Provisional application No. 61/703,510, filed on Sep. 20, 2012.

(51) Int. Cl. G06Q 10/06

(52) U.S. Cl. CPC G06Q 10/06398
USPC 705/7.42

(57) ABSTRACT

A plan to incentivize performance is obtained based on objective and subjective metrics. A first step encompasses understanding the effect of actions on each objective metric on future service provider performance. A subset of objective metrics is obtained via regression analysis. For the subset identified in the first step, a set of clusters is identified in the multi-dimensional space of objective metrics. For each cluster, actions based on service provider performance relating to subjective metrics are effected. Expert guidance based on macroeconomic factors are further considered.

### CROSS REFERENCE TO RELATED APPLICATION

This application claims the benefit of U.S. Provisional Application No. 61/703,510 filed Sep. 20, 2012, the subject matter of which is incorporated by reference herein.

### FIELD

The present invention relates to the electrical, electronic and computer arts, and, more particularly, to the use of objective and subjective metrics to facilitate the achievement of performance goals.

### BACKGROUND

Performance based plans for facilitating service provider performance can be challenging in business environments where provider success is influenced by multiple metrics, both objective and subjective. Sales incentive plans, for example, while acceptable for service providers in certain environments, may not be suitable for providers operating in other environments. Expectancy theory posits that if individuals expect to receive a valued reward for high performance, they are more likely to strive to perform at high levels than when no such reward is expected.

Some systems employ ad-hoc rules or formulae for rewarding service providers based on performance. Rewards based on revenue generation and/or project delivery are employed in other systems.

### SUMMARY

Principles of the disclosed embodiments provide techniques and systems for designing incentive plans using multiple metrics of success, both objective and subjective. In one aspect, an exemplary method includes the steps of correlating a plurality of selected actions with a plurality of objective metrics, obtaining a subset of objective metrics based on correlation of the selected actions with the plurality of objective metrics, and, for the subset of objective metrics, identify a set of clusters in a multidimensional space. For each cluster identified, the method includes adjusting a service provider compensation action based on the subjective metrics.

An exemplary apparatus includes a memory having stored therein information relating to service provider objective metrics, subjective metrics, and selected compensation-related actions and at least one processor, coupled to said memory, and operative to: i) correlate a plurality of the selected actions with a plurality of the objective metrics; ii) obtain a subset of objective metrics based on correlation of the selected actions with the plurality of objective metrics; iii) for the subset of objective metrics, identify a set of clusters in a multidimensional space; iv) for each cluster identified, adjust a service provider compensation action based on the subjective metrics.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
Principled methodology for categorization so as to apply differentiated incentives;
Simultaneous consideration of financial and non-financial metrics in designing performance plans;
Systematic determination of optimal weighting of each factor employed in designing performance plans.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a system for designing an incentive plan based on a three step method;

FIGS. 2A-B are two subplots depicting a three-dimensional space and illustrate three clusters obtained via execution of a clustering module in accordance with an aspect of the invention;

FIG. 3 shows a flow diagram showing an exemplary method of estimating the reward or return a company is likely to receive relative to the risk of operating in a particular country;

FIG. 4 depicts a computer system that may be useful in implementing one or more aspects and/or elements of the invention, and

FIG. 5 depicts a graph plotting values (ICF) obtained from a method described below with respect to values based on subjective metrics (e.g., a subjective performance metric or SPM).

### DETAILED DESCRIPTION

A system and method for designing an incentive plan to incent performance of service providers is disclosed herein. The system and method address environments characterized by multiple metrics of success, both objective and subjective. The success of business consultants, business partners, and others persons or entities providing services to an entity can be measured in a number of ways. In terms of sales data, success can be quantified in terms of the value of new contracts obtained ($signings), contract signings as a percentage of potential customer targets (%attainments), the gross profit of one or more projects (Project GP), and gross profit percentage (GP %). Such parameters are considered exemplary as opposed to limiting. Other, sometimes more subjective parameters for evaluating service providers, include personnel management, practice development, and business management.

An exemplary system and method includes a three step approach for designing a plan to simultaneously incent performance using objective and subjective metrics. An initial step in the approach relates to understanding the effect of compensation on each objective metric in a subsequent year. It will be appreciated that the time period can be longer or shorter than a year in other exemplary embodiments. (Compensation can involve monetary and/or other consideration provided or action taken with respect to a service provider, including monetary and non-monetary awards, citations, etc.) A determination is made as to whether compensation is correlated with objective metrics, for example $signings and Project GP. One possible technique is linear regression, though other techniques familiar to those of skill in the art, for example logistic regression and nonlinear regression, may be employed. The second part of the first step includes determining objective metrics that are significant in a multivariate regression analysis. Any one of a class of regression algorithms such as linear regression, logistic regression, and nonlinear regression may be employed. The first and second parts of the first step are performed sequentially and yield a subset of objective metrics. The first step may be performed using a correlation module and a regression analysis module. The correlation module 104 is a software component which, when executed on one or more hardware processors, carries out the function of determining whether compensation is indeed correlated with selected objective metrics. As some forms of compensation may be correlated with one or more objective metrics and others may not be, a plurality of actions (e.g. bonuses, awards, news citations) are considered with respect to the objective metrics. Regression analysis module 106 is a software component which, when executed on one or more hardware processors, carries out the functions of the regression analysis as described above and outputs the subset of objective metrics for further processing. Any computer-executed implementation of regression analysis and dimensionality reduction (for example, as built into commercially available statistical analysis programs such as SPSS) can be employed to complete this first step.

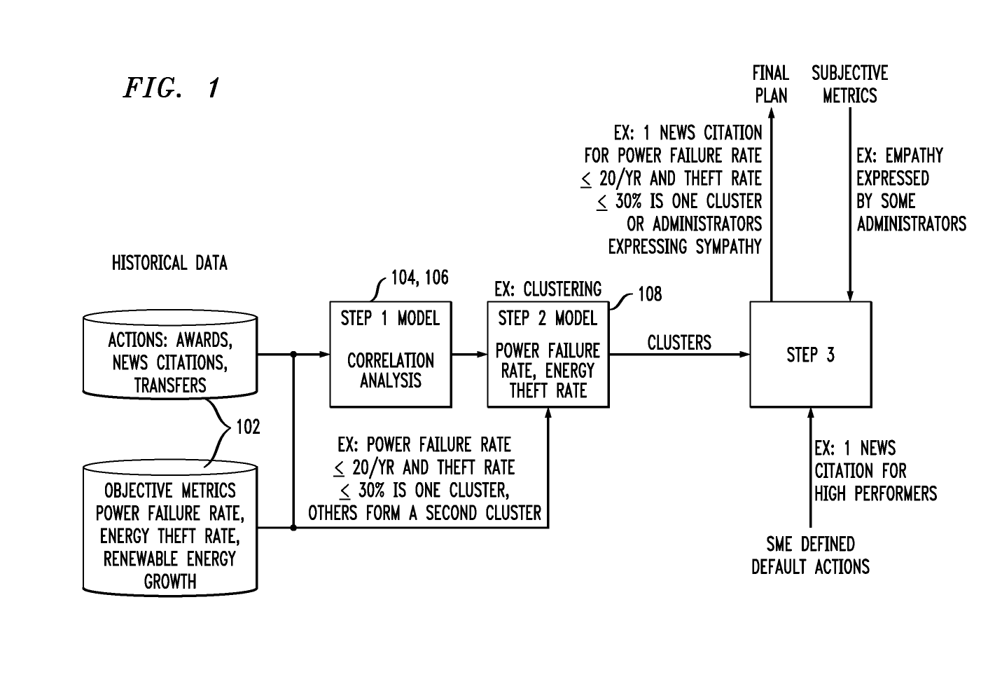

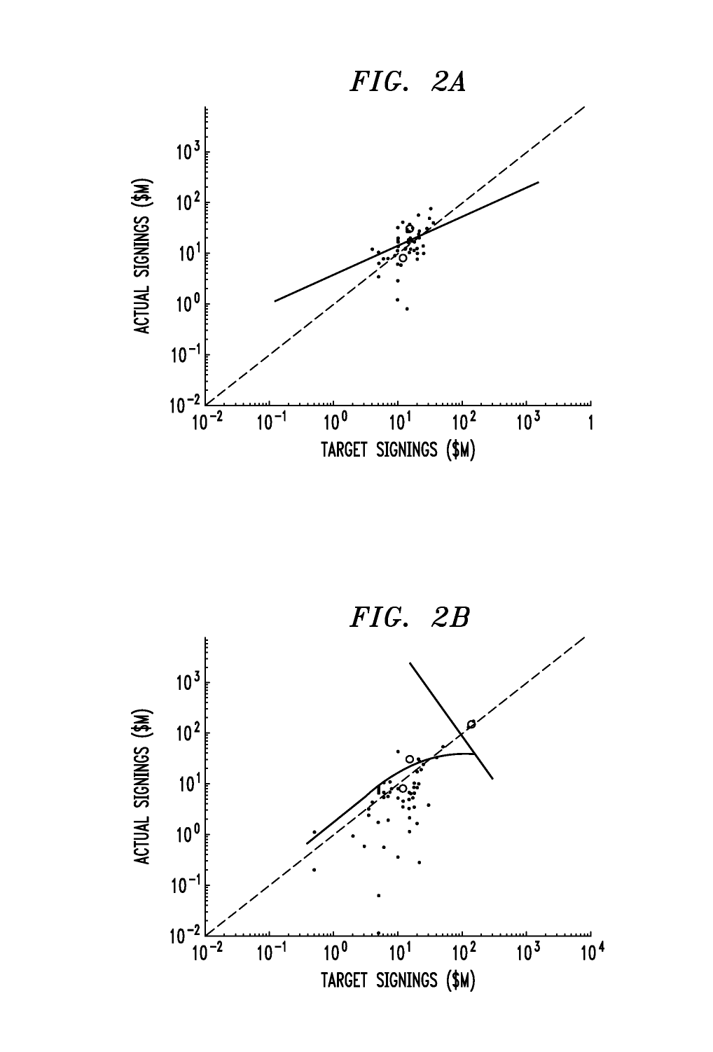

For the subset of objective metrics identified in the first step following regression analysis, a set of clusters in the multi-dimensional space of objective metrics is obtained. There is a set of data lying in the multi-dimensional space of objective metrics. The data is clustered into categories using a clustering algorithm such as k-means clustering. Categories obtained comprise the sets of clusters. Any computer-implemented implementation of k-means clustering, whether with the Lloyd-Max algorithm or MacQueen's algorithm or other algorithms such as built into a computing environment such as MATLAB. Clustering module 108 is a software component which, when executed on one or more hardware processors, carries out the functions of identifying clusters in the multi-dimensional space of objective metrics as described above. FIG. 1 shows an exemplary system including memories 102 for storing selected information such as actions and objective metrics and the arrangement of software modules. FIGS. 2A-B are two subplots depicting a three-dimensional space and illustrate three clusters obtained via execution of the clustering module. In this example, the objective metrics forming the coordinates are actual signings and target signings, both expressed in terms of dollars. The lines are generalized partitions between the categories. The dark lines in the graphs are generalized partitions between categories. In the subplot of FIG. 2A, the cluster 1 category is above the dark line and the cluster 2 category is below it. The subplot of FIG. 2A further relates to providers having a relatively high rating based on subjective metrics. The subplot of FIG. 2B relates to providers having a lower rating based on subjective metrics. The partition lines are generated, in this example, using a computer-executed implementation of a maximum margin partition algorithm. An underlying assumption in the exemplary graphs is that signings and target distributions are stationary year over year. To facilitate implementation, categories from optimal clustering are approximated in some embodiments using piecewise linear boundaries in the linear domain (rather than the log domain).

The third step employs the clusters identified in the second step described above. For each cluster identified, subject matter expert (SME) defined default compensation increases are perturbed (adjusted) based on, for example, 1) expert guidance on macroeconomic factors such as industry trends, and 2) performance on subjective metrics such as personnel management. The third step is domain specific, so algorithms would be developed to meet the specific criteria. For example, if a subjective metric such as eminence is high, the action taken with respect to compensation of the service provider could be adjusted by a selected percentage. If eminence is not high, no change in action is taken. With respect to a business consultant, the term “eminence” relates to distinction and/or high standing in a given industry. Other macroeconomic or subjective metrics could be incorporated in the algorithm to adjust the compensation action positively or negatively.

A first exemplary environment wherein the process as described above may be employed is the field of information technology services. Quantitative performance metrics in this area include, for example, profitability, number of service interruptions, unplanned capacity adjustments, number of major security incidents, and average time to resolve incidents. Qualitative metrics include customer satisfaction, flexibility in responding to customer requests and reputation. Compensation of IT service providers is commonly based on fixed-price or time and materials contracts with limited incentives. The process provided herein allows an entity to determine appropriate service delivery contracts to be offered to such service providers based on quantitative (objective) and qualitative (subjective) metrics. The contracts are tailored to drive a higher quality of service delivery. Exemplary steps include the following:
Step 1—Understanding the costs for different service models. Model the effects of resource usage for higher service levels (costs) on the objective metrics, such as number of service interruptions and number of security incidents. For example, using data from a number of client engagements, are costs for higher service levels correlated with reduced service interruptions and security breaches?
Step 2—For the subset of metrics identified in step 1, identify a set of clusters in the multi-dimensional space of objective metrics. For example:
Two metrics identified: Number of service interruptions, number of security breaches.
In this space, two clusters A and B are determined:
   A: Less than ten (10) service interruptions/month, 2-5 security breaches;
   B: Ten (10) or more service interruptions/month, less than two (2) security breaches
Step 3—For each cluster identified in Step 2, the prescribed recommendations are perturbed based on:
SME input on economic/market factors and industry trends, i.e., cost of services in the marketplace;
Subjective metrics, such as reputation of the service provider.

A second exemplary environment that could potentially benefit from the process discussed above is the field of medical care. Quantitative (objective) metrics for possible consideration include patient satisfaction scores, hospital readmission rates, death rates, and diagnostic quality and/or speed. Qualitative (subjective) metrics include reputation eminence, and bedside manner. These metrics are exemplary as opposed to limiting.

A third environment for employing the disclosed method is in the field of education. Quantitative metrics in this field include student attendance, test scores, and graduation rates. Qualitative metrics include in-class teacher observations, teacher eminence, student conduct, and development of student talents. The method may be employed to incentivize performance of teachers or teaching institutions. For example, teacher bonuses are only one way to support the goal of providing a beneficial education to students. Analytics-driven differentiation employing the method disclosed above can simultaneously induce high performance on both quantitative and qualitative metrics for both teachers and students while avoiding issues relating to “teaching to the test.” The analytics discussed above provides prescriptive rules to drive higher quality education through a combination of incentives including, for example, teacher bonus pay, student/class access to limited resources, and additional funds to support enrichment activities such as field trips.

A fourth environment for employing the disclosed method is in service management, where the performance of administrators or other supervisory personnel involves multiple metrics of success, both objective and subjective. For example, an administrator of a public utility responsible for power generation and/or distribution may be provided with performance incentives based on implementation of the disclosed method. Exemplary objective metrics include power failure rate, energy theft rate, and renewable energy growth. Subjective metrics include personnel management and media management. The disclosed three step approach can be employed to design a plan to simultaneously incent performance on objective and subjective metrics: 1) Understand the effect of actions (awards, news citations, transfers) on each objective metric in the subsequent year; 2) for the subset of metrics identified in step 1), identify a set of clusters in the multi-dimensional space of objective metrics; 3) for each cluster identified in step 2, SME defined default are perturbed based on a) expert guidance on local factors (e.g. unhelpful local government), industry trends (weather effects on hydro-electric generation capacity) and b) performance on subjective metrics such as personnel management. For example, with respect to cluster 1, the default action in an exemplary embodiment is a bonus of ten percent of a contractual amount, while the perturbed action would be a twelve percent bonus.

Referring to FIG. 1, historical data including actions and objective metrics relating to the fourth environment discussed above are stored electronically in memories 102. The clustering and regression analysis modules 104, 106 are employed to execute he step 1 model to understand the effect of the actions (e.g. awards, news citations, transfers) on each objective metric (e.g. power failure rate, energy theft rate, etc.). From the subset of objective metrics identified using the step 1 model, a set of clusters is identified using the clustering module 108 executing the step 2 model as described above. In this example, power failure rate and power theft rates were among the objective metrics determined to be significant in step 1. For each cluster identified in step 2, SME defined default actions (e.g. default compensation increases) are perturbed based on expert guidance with respect to, for example, industry trends and for subjective metrics (for example, empathy). The “final plan” as indicated in FIG. 1 relates to selected actions likely to be effective in incenting performance based on steps 1-3.

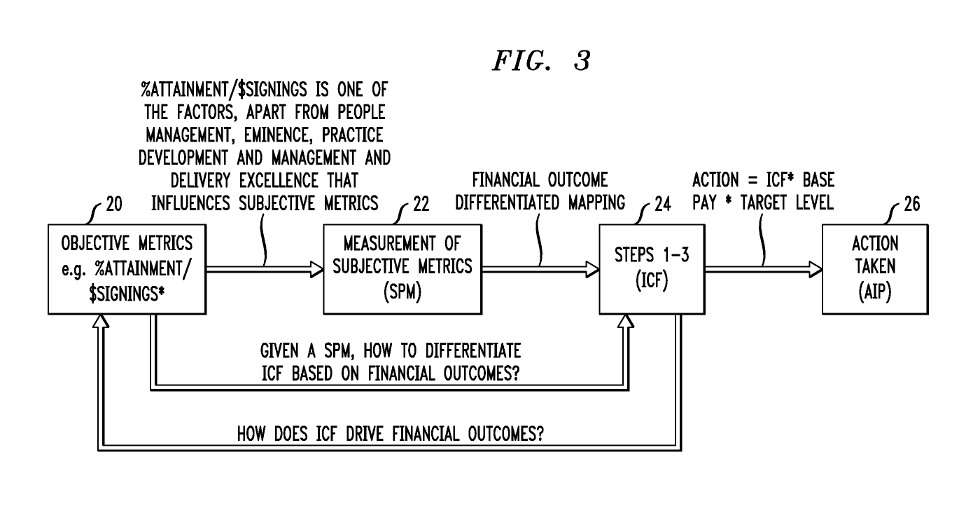

A flow chart relating to a further application of the disclosed method is shown in FIG. 3. This application relates to the assessment of business consultants employed by an entity. The first box 20 represents relevant objective metrics applicable to the productivity of the business consultants in a particular exemplary operating environment. As discussed above, such objective metrics are stored in an electronic memory. In this exemplary embodiment, %attainment and $signings are two of the objective metrics relevant to the effectiveness of the business consultants. The second box 22, designated SPM relates to subjective metrics. SPM is a numerical expression of a subjective factor. As indicated in the flow chart, while subjective metrics are considered to include personnel management and other metrics, objective metrics can influence SPM. The third box 24 in the flow chart, designated ICF, represents the three step process described above to understand the effect of actions (e.g. compensation levels, citations, bonuses) on each objective metric, identify clusters in the multi-dimensional space of objective metrics and, for each cluster, adjusting a default compensation for the business consultant based on macroeconomic factors and performance relating to subjective metrics such as personnel management. The fourth box 28 in the flow chart is designated AIP and represents the action(s) taken by the entity with respect to the business consultant following execution of the three step process. AIP is the action which is determined as a particular formula of the ICF, which is an intermediate variable. When determining ICF, the subjective factors (SPM) are already taken into account.

FIG. 5 provides a graph plotting values obtained from steps 1-3 (the ICF) with respect to subjective metrics (SPM). In the exemplary graph, ratings are assigned to service providers based on subjective metrics such as personnel management. SPM rating is determined by a human agent assessing the subjective factors considered relevant to the service to be provided by the contractor. In this particular example, the ratings are, in descending order, 1, 2+, 2 and 3. The ICF values range from 0-2. The graph indicates that the subjective ranking does indeed have a correlation to ICF, but not a strong correlation. Appropriate steps can be taken in view of such results to shape the ICF variation, linking it more closely to contractor performance (e.g. %attainment and/or $signings).

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

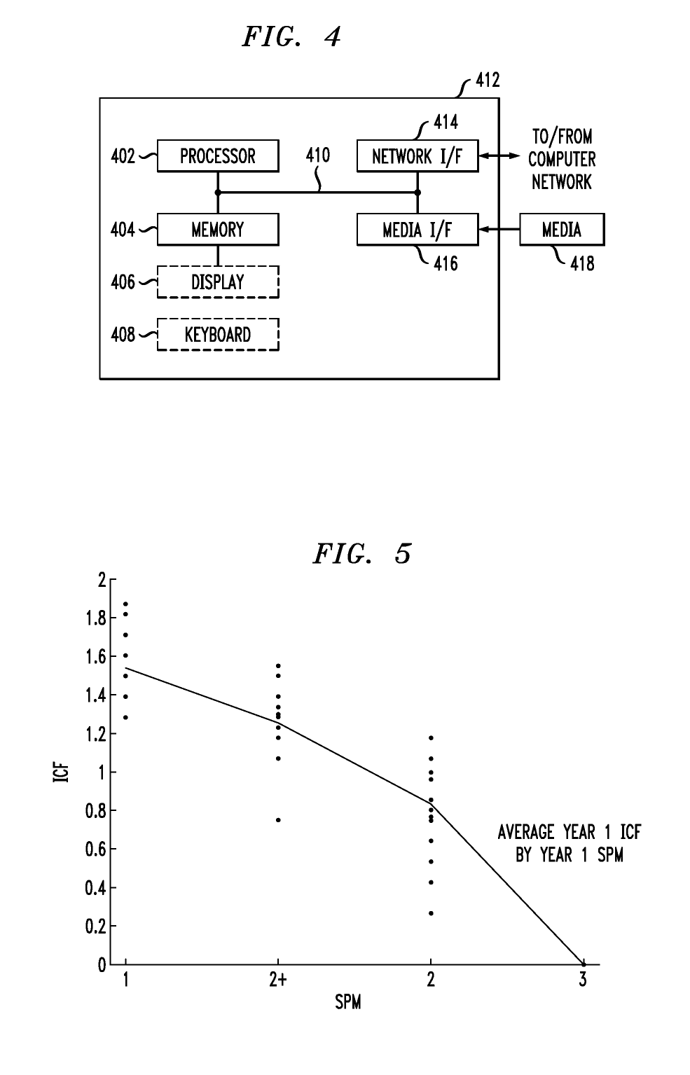

One or more embodiments can make use of software running on a general purpose computer or workstation. With reference to FIG. 4 such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation. The memory elements 404 comprise the memories 102 described above in this exemplary embodiment.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A non-transitory computer readable medium may embody instructions executed by the processor to perform estimation of the risk and reward of operation in a particular country as described above.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, the correlating module, the regression analysis module and the clustering module. The three step method can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a memory having stored therein information relating to service provider objective metrics, subjective metrics, and selected compensation-related actions; and
at least one processor, coupled to said memory, and operative to:
correlate a plurality of the selected actions with a plurality of the objective metrics;
obtain a subset of objective metrics based on correlation of the selected actions with the plurality of objective metrics;
for the subset of objective metrics, identify a set of clusters in a multidimensional space;
for each cluster identified, adjust a service provider compensation action based on the subjective metrics.

2. The apparatus of claim 1, wherein the processor is further operative to adjust the service provider compensation action based on macroeconomic factors and/or industry trends.

3. The apparatus of claim 2, wherein the processor is further operative to obtain the subset of objective metrics via multivariate regression analysis.

4. The apparatus of claim 3, wherein the processor is further operative to identify the set of clusters via k-means clustering.

5. The apparatus of claim 2, further comprising a plurality of distinct software modules, each of the distinct software modules being embodied on a non-transitory computer-readable storage medium, and wherein the distinct software modules comprise a regression analysis module and a clustering module;
wherein:
said at least one processor is operative to obtain the subset of objective metrics by executing said regression analysis module and identify the clusters by executing on the clustering module.

6. The apparatus of claim 5, wherein the distinct software modules further comprise a correlating module wherein:
said at least one processor is operative to correlate a plurality of the selected actions with a plurality of the objective metrics by executing on the correlating module.

7. A computer program product comprising a computer readable storage medium having computer readable program code embodied therewith, said computer readable program code comprising:
computer readable program code configured to determine whether a plurality of compensation actions are correlated with a plurality of selected objective metrics relating to service provider performance;
computer readable program code configured to identify, via multivariate regression analysis, a subset of the selected objective metrics considered significant following correlation of the plurality of compensation actions with the plurality of selected objective metrics;
computer readable program code configured to, for the subset of objective metrics identified, identify a set of clusters in a multi-dimensional space; and
computer readable program code configured to determine, for each cluster identified, at least one action to take based on subjective metrics relating to the service provider.

8. The computer program product of claim 7, further including computer readable program code configured to determine, for each cluster identified, the at least one action based on macroeconomic factors and/or industry trends.

9. The computer program product of claim 8, wherein the computer readable program code configured to, for the subset of objective metrics identified, identify a set of clusters in a multi-dimensional space, is further configured to perform k-means clustering.
